(19) United States
(12) Patent Application Publication
(10) Pub. No.: US 2011/0043311 A1
(43) Pub. Date: Feb. 24, 2011

(54) PERMANENT MAGNET AND PROCESS FOR PRODUCING PERMANENT MAGNET

(75) Inventors: Izumi Ozeki, Osaka (JP); Katsuya Kume, Osaka (JP); Junichi Nakayama, Osaka (JP); Yuuki Fukuda, Osaka (JP); Toshinobu Hoshino, Osaka (JP); Tomokazu Horio, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Ibaraki-shi, Osaka (JP)

(21) Appl. No.: 12/937,870

(22) PCT Filed: Apr. 14, 2009
(86) PCT No.: PCT/JP2009/057532

§ 371 Date: Oct. 14, 2010

(30) Foreign Application Priority Data
Apr. 15, 2008 (JP) 2008-105761

(51) Int. Cl. H01F 7/02; B28B 1/24

(52) U.S. Cl. 335/302; 264/612

(57) ABSTRACT

The present invention relates to a permanent magnet manufactured by steps of: pulverizing a magnet raw material; mixing the pulverized magnet raw material with a rust preventive oil in which a Dy compound or a Tb compound is dissolved, thereby preparing a slurry; compression molding the slurry to form a molded body; and sintering the molded body.

### TECHNICAL FIELD

The present invention relates to a permanent magnet and a method for manufacturing the permanent magnet.

### BACKGROUND ART

In recent years, a reduction in size and weight, an increase in power and an increase in efficiency have been required for permanent magnetic motors used in hybrid cars, hard disk drives or the like. Then, in realizing a reduction in size and weight, an increase in power and an increase in efficiency in the above-mentioned permanent magnetic motors, a reduction in film thickness and further improvement in magnetic characteristics have been required for permanent magnets buried in the permanent magnetic motors. Incidentally, as the permanent magnets, there are ferrite magnets, Sm—Co-based magnets, Nd—Fe—B-based magnets, Sm₂Fe₁₇Nₓ-based magnets and the like. In particular, Nd—Fe—B-based magnets having high coercive force are used as the permanent magnets for the permanent magnet motors.

Here, as a method for manufacturing the permanent magnet, a powder sintering method is generally used. In the powder sintering method as used herein, a raw material is first pulverized with a jet mill (dry pulverization) to produce a magnet powder. Thereafter, the magnet powder is placed in a mold, and press molded to a desired shape while applying a magnetic field from the outside. Then, the solid magnet powder molded to the desired shape is sintered at a predetermined temperature (for example, 1100° C. in the case of the Nd—Fe—B-based magnet), thereby manufacturing the permanent magnet.

Further, in the powder sintering method, when the raw material is pulverized with the jet mill, a slight amount of oxygen is usually introduced into the jet mill to control the oxygen concentration in nitrogen gas or Ar gas as a pulverizing medium to a desired range. This is because a surface of the magnet powder is forced to be oxidized, and the magnetic powder finely pulverized without this oxidation treatment ignites at the same time that it comes into contact with the air. However, most of oxygen in a sintered body obtained by sintering the magnetic powder subjected to the oxidization treatment is combined with a rare-earth element such as Nd to exist as an oxide in a grain boundary. Accordingly, in order to supplement the oxidized rare-earth element, it is necessary to increase the total amount of the rare-earth element in the sintered body. However, when the total amount of the rare-earth element in the sintered body is increased, there is a problem that the saturation magnetic flux density of the sintered magnet is decreased.

Accordingly, patent document 1 (JP-A-2004-250781 (Pages 10 to 12, FIG. 2) discloses a production method of, when a rare-earth magnet raw material is pulverized in a jet mill, recovering the pulverized magnet raw material in a rust preventive oil such as a mineral oil or a synthetic oil to form a slurry, wet molding this slurry in a magnetic field while performing deoiling, subjecting the molded body to deoiling treatment in vacuo, and performing sintering.

### BACKGROUND ART DOCUMENTS

### Patent Documents

Patent Document 1: JP-A-2004-250781 (Pages 10 to 12, FIG. 2)

### SUMMARY OF THE INVENTION

On the other hand, when a Nd-based magnet such as the Nd—Fe—B-based magnet is used in the permanent magnetic motor, Dy (dysprosium) is added to further improve coercive force of the magnet, in order to improve the output of the motor. This is caused by that Dy is solid-solutionized in magnet particles. However, in a conventional method for manufacturing the Nd-based magnet, a large amount of Dy becomes necessary for solid-solutionizing Dy in the magnet particles to sufficiently achieve improvement in coercive force of the magnet. For example, the amount of Dy required to be added has been from 20 to 30 wt % based on Nd.

However, Dy is a rare metal, and the locality thereof is limited, so that it is desirable to reduce the amount of Dy used, based on Nd, as much as possible.

Further, when Dy added as described above is solid-solutionized in the magnet particles, this contributes to a decrease in residual magnetization of the magnet.

Accordingly, a technique for largely improving the coercive force of the magnet by addition of a slight amount of Dy without a decrease in residual magnetization has been desired.

The invention has been made in order to solve the above-mentioned conventional problems, and an object of the invention is to provide a permanent magnet in which oxidation of a pulverized magnet raw material can be prevented by mixing the magnet raw material with a rust preventive oil and in which it becomes possible to unevenly distribute a slight amount of Dy or Tb dissolved in the mixed rust preventive oil in grain boundaries of magnet particles, thereby being able to sufficiently improve the residual magnetization and coercive force due to Dy or Tb while decreasing the amount of Dy or Tb used; and a method for manufacturing the permanent magnet.

Namely, the present invention relates to the following items (1) to (10).

(1) A permanent magnet manufactured by steps of:

pulverizing a magnet raw material;

mixing the pulverized magnet raw material with a rust preventive oil in which a Dy compound or a Tb compound is dissolved, thereby preparing a slurry;

compression molding the slurry to form a molded body; and

sintering the molded body.

(2) The permanent magnet according to (1), in which the Dy compound or the Tb compound is unevenly distributed in a grain boundary of the magnet raw material after sintering.

(3) The permanent magnet according to (1) or (2), in which the Dy compound or the Tb compound is contained in an amount of from 0.01 to 8 wt %.

(4) A permanent magnet manufactured by steps of:

pulverizing a magnet raw material;

mixing the pulverized magnet raw material with a rust preventive oil in which fine Dy particles or fine Tb particles are dissolved, thereby preparing a slurry;

compression molding the slurry to form a molded body; and

sintering the molded body.

(5) The permanent magnet according to (4), in which the fine Dy particles or the fine Tb particles are unevenly distributed in a grain boundary of the magnet raw material after sintering.

(6) The permanent magnet according to (4) or (5), in which the fine Dy particles or the fine Tb particles are contained in an amount of from 0.01 to 8 wt %.

(7) A method for manufacturing a permanent magnet, including steps of:

pulverizing a magnet raw material;

mixing the pulverized magnet raw material with a rust preventive oil in which a Dy compound or a Tb compound is dissolved, thereby preparing a slurry;

compression molding the slurry to form a molded body; and

sintering the molded body.

(8) The permanent magnet according to (7), in which the Dy compound or the Tb compound is contained in an amount of from 0.01 to 8 wt %.

(9) A method for manufacturing a permanent magnet, including steps of:

pulverizing a magnet raw material;

mixing the pulverized magnet raw material with a rust preventive oil in which fine Dy particles or fine Tb particles are dissolved, thereby preparing a slurry;

compression molding the slurry to form a molded body; and

sintering the molded body.

(10) The permanent magnet according to (9), in which the fine Dy particles or the fine Tb particles are contained in an amount of from 0.01 to 8 wt %.

According to the permanent magnet having the constitution of the above (1), oxidation of the pulverized magnet raw material can be prevented by mixing the magnet raw material with the rust preventive oil. Further, it becomes possible to unevenly distribute a slight amount of the Dy compound or the Tb compound dissolved in the mixed rust preventive oil in grain boundaries of magnet particles, whereby it becomes possible to sufficiently improve the coercive force due to Dy or Tb while decreasing the amount of Dy or Tb used. Furthermore, it can be prevented that Dy or Tb is solid-solutionized in the magnet particles to decrease the residual magnetization.

In addition, according to the permanent magnet described in the above (2), the Dy compound or the Tb compound is unevenly distributed in the grain boundary of the magnet raw material after sintering, so that it becomes possible to sufficiently improve the coercive force due to Dy or Tb while decreasing the amount of Dy or Tb used.

Further, according to the permanent magnet described in the above (3), the content of the above-mentioned Dy compound or Tb compound is from 0.01 to 8 wt %, so that it becomes possible to sufficiently improve the residual magnetization and coercive force by Dy or Tb while decreasing the amount of Dy or Tb used.

Furthermore, according to the permanent magnet described in the above (4), oxidation of the pulverized magnet raw material can be prevented by mixing the magnet raw material with the rust preventive oil. Further, it becomes possible to unevenly distribute a slight amount of the fine Dy particles or the fine Tb particles dissolved in the mixed rust preventive oil in grain boundaries of magnet particles, whereby it becomes possible to sufficiently improve the coercive force due to Dy or Tb while decreasing the amount of Dy or Tb used. In addition, it can be prevented that Dy or Tb is solid-solutionized in the magnet particles to decrease the residual magnetization.

Further, according to the permanent magnet described in the above (5), the fine Dy particles or the fine Tb particles are unevenly distributed in grain boundaries of magnet particles, so that it becomes possible to sufficiently improve the coercive force due to Dy or Tb while decreasing the amount of Dy or Tb used.

Furthermore, according to the permanent magnet described in the above (6), the content of the above-mentioned fine Dy particles or fine Tb particles is from 0.01 to 8 wt %, so that it becomes possible to sufficiently improve the residual magnetization and coercive force by Dy or Tb while decreasing the amount of Dy or Tb used.

In addition, according to the method for manufacturing a permanent magnet described in the above (7), oxidation of the pulverized magnet raw material can be prevented by mixing the magnet raw material with the rust preventive oil. Further, it becomes possible to unevenly distribute a slight amount of the Dy compound or the Tb compound dissolved in the mixed rust preventive oil in grain boundaries of magnet particles, whereby it becomes possible to manufacture the permanent magnet improved in the coercive force due to Dy or Tb while decreasing the amount of Dy or Tb used. Furthermore, it can be prevented that Dy or Tb is solid-solutionized in the magnet particles to decrease the residual magnetization.

Further, according to the method for manufacturing a permanent magnet described in the above (8), the content of the above-mentioned Dy compound or Tb compound is from 0.01 to 8 wt %, so that it becomes possible to sufficiently improve the residual magnetization and coercive force by Dy or Tb while decreasing the amount of Dy or Tb used.

Further, according to the method for manufacturing a permanent magnet described in the above (9), oxidation of the pulverized magnet raw material can be prevented by mixing the magnet raw material with the rust preventive oil. Furthermore, it becomes possible to unevenly distribute a slight amount of the fine Dy particles or the fine Tb particles dissolved in the mixed rust preventive oil in grain boundaries of magnet particles, whereby it becomes possible to manufacture the permanent magnet improved in the coercive force due to Dy or Tb while decreasing the amount of Dy or Tb used. In addition, it can be prevented that Dy or Tb is solid-solutionized in the magnet particles to decrease the residual magnetization.

Further, according to the method for manufacturing a permanent magnet described in the above (10), the content of the above-mentioned fine Dy particles or fine Tb particles is from 0.01 to 8 wt %, so that it becomes possible to sufficiently improve the residual magnetization and coercive force by Dy or Tb while decreasing the amount of Dy or Tb used.

### BRIEF DESCRIPTION OF THE DRAWINGS

FIG. 1 is an overall view showing a permanent magnet according to the present embodiment.

FIG. 2 is an enlarged view showing Nd magnet particles constituting a permanent magnet.

FIG. 3 is a graph showing a hysteresis curve of a ferromagnetic body

FIG. 4 is a schematic view showing a magnetic domain structure of a ferromagnetic body.

FIG. 5 is an explanatory view showing a manufacturing process of the permanent magnet according to the present embodiment.

### MODE FOR CARRYING OUT THE INVENTION

A specific embodiment of a permanent magnet and a method for manufacturing the permanent magnet according to the invention will be described below in detail with reference to the drawings.

Constitution of Permanent Magnet

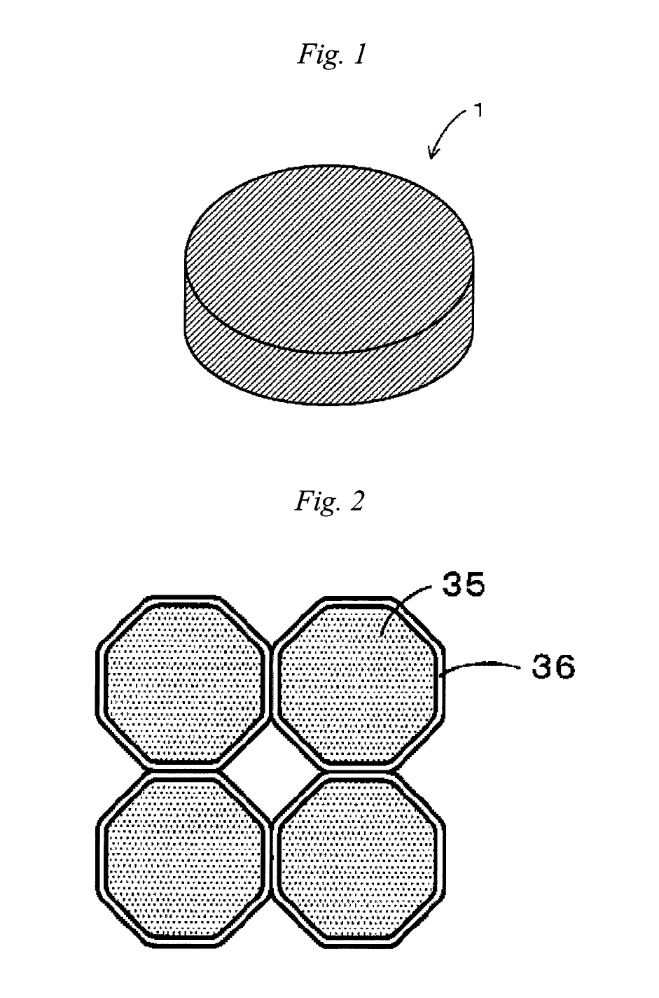

First, a constitution of a permanent magnet 1 will be described using FIGS. 1 to 4.

The permanent magnet 1 according to this embodiment is a Nd—Fe—B-based magnet. Further, Dy (dysprosium) for increasing the coercive force of the permanent magnet 1 is added. Incidentally, the contents of respective components are regarded as Nd: 27 to 30 wt %, a Dy component contained in a Dy compound (or a Tb component contained in a Tb compound): 0.01 to 8 wt %, B: 1 to 2 wt %, and Fe (electrolytic iron): 60 to 70 wt %. Furthermore, the permanent magnet 1 according to this embodiment has a cylindrical shape as shown in FIG. 1, but the shape of the permanent magnet 1 varies depending on the shape of a cavity used in molding. FIG. 1 is an overall view showing the permanent magnet 1 according to this embodiment.

Then, the permanent magnet 1 is prepared by pouring an Nd magnet powder mixed with a rust preventive oil to form a slurry state as described later into the cavity having a shape corresponding to an outer shape of a molded body to be molded, and sintering the molded article which has been compression molded.

Further, in the permanent magnet 1 according to this embodiment, as shown in FIG. 2, surfaces of Nd magnet particles 35 constituting the permanent magnet 1 are coated with Dy layers 36, thereby improving the coercive force of the permanent magnet 1. FIG. 2 is an enlarged view showing the Nd magnet particles constituting the permanent magnet 1.

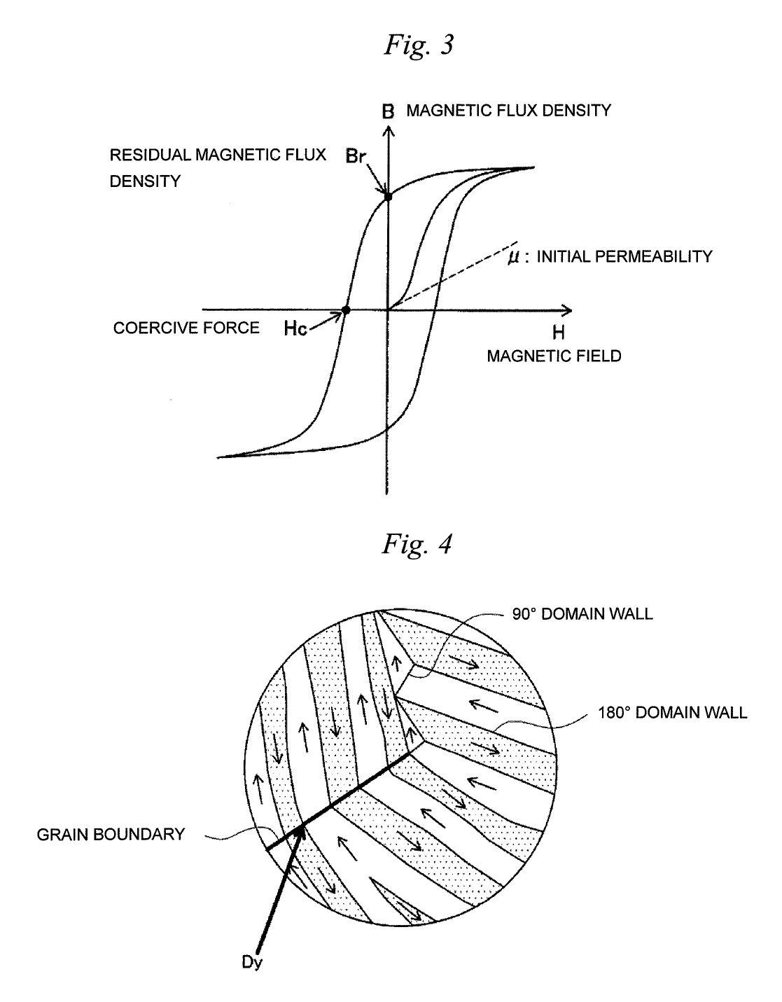

A mechanism of improving the coercive force of the permanent magnet 1 with the Dy layers 36 will be described below using FIG. 3 and FIG. 4. FIG. 3 is a graph showing a hysteresis curve of a ferromagnetic body, and FIG. 4 is a schematic view showing a magnetic domain structure of the ferromagnetic body.

As shown in FIG. 3, the coercive force of the permanent magnet is the intensity of a magnetic field necessary for making magnetic polarization zero (that is to say, for magnetization reversal) when the magnetic field is applied from a magnetized state in the opposite direction. Accordingly, if the magnetization reversal can be inhibited, high coercive force can be obtained. Incidentally, magnetization processes of a magnetic body include rotational magnetization based on rotation of magnetic moment and domain wall displacement in which domain walls (consisting of a 90° domain wall and a 180° domain wall) as boundaries of magnetic domains move.

Here, in this embodiment, when the magnet powder is finely pulverized by dry pulverization as described later, the rust preventive oil in which a slight amount (for example, 0.01 to 8 wt % based on the magnet powder (the amount of Dy added based on Nd, being taken as weight conversion of Dy distribution particularly when a Dy compound is added) of the Dy compound is dissolved is mixed with a finely pulverized magnet powder. This causes the Dy compound to be uniformly adhered to the particle surfaces of the Nd magnet particles 35 to form the Dy layers 36 shown in FIG. 2, when the magnet powder mixed with the rust preventive oil is sintered thereafter. As a result, Dy is unevenly distributed in a boundary face of the magnet particle as shown in FIG. 4, thereby being able to improve the coercive force of the permanent magnet 1.

Further, in this embodiment, when the molded body molded by compression molding is sintered under proper sintering conditions, Dy can be prevented from being diffused and penetrated (solid-solutionized) into the magnet particles 35. Here, it is known that the diffusion and penetration of Dy into the magnet particles 35 decreases the residual magnetization (magnetization at the time when the intensity of the magnetic field is made zero) of the magnet. Accordingly, in this embodiment, the residual magnetization of the permanent magnet 1 can be prevented from being decreased.

Incidentally, the Dy layers 36 are not required to be a layer composed of only the Dy compound, and may be a layer composed of a mixture of the Dy compound and a Nd compound. In that case, the layer composed of the mixture of the Dy compound and the Nd compound is formed by adding the Nd compound. As a result, liquid-phase sintering of the Nd magnet powder at the time of sintering can be promoted. Incidentally, as the Nd compound to be added, desirable is neodymium acetate hydrate, neodymium (III) acetylacetonate trihydrate, neodymium (III) 2-ethylhexanoate, neodymium (III) hexafluoroacetylacetonate dihydrate, neodymium isopropoxide, neodymium (III) phosphate n-hydrate, neodymium trifluoroacetylacetonate, neodymium trifluoromethanesulfonate or the like. Further, as the Tb compound to be added, desirable is terbium (III) acetate n-hydrate, terbium (III) acetate tetrahydrate, terbium (III) acetylacetonate trihydrate, terbium (III) oxalate hexahydrate, terbium (III) bromide, terbium (III) carbonate n-hydrate, terbium (III) chloride anhydride, terbium (III) chloride hexahydrate, terbium (III) fluoride, terbium fluoride oxide, terbium (III) hydride, terbium (III) nitrate hexahydrate or terbium sulfide.

Further, it is also possible to similarly improve the coercive force of the permanent magnet 1 by mixing the rust preventive oil in which the Tb (terbium) compound is dissolved in place of the Dy compound with the finely pulverized magnet powder. When the Tb compound is dissolved, Tb compound layers are similarly formed on the surfaces of the Nd magnet particles 35. Then, the coercive force of the permanent magnet 1 can be further improved by forming the Tb layers.

Furthermore, it is also possible to similarly improve the coercive force of the permanent magnet 1 by mixing the rust preventive oil in which fine Dy particles or fine Tb particles are dissolved in place of the Dy compound with the finely pulverized magnet powder. When the fine Dy particles are dissolved, the fine Dy particles are adhered to the surfaces of the Nd magnet particles 35 to form the Dy layers. On the other hand, when the fine Tb particles are dissolved, the fine Tb particles are adhered to the surfaces of the Nd magnet particles 35 to form the Tb layers.

Method for Manufacturing Permanent Magnet

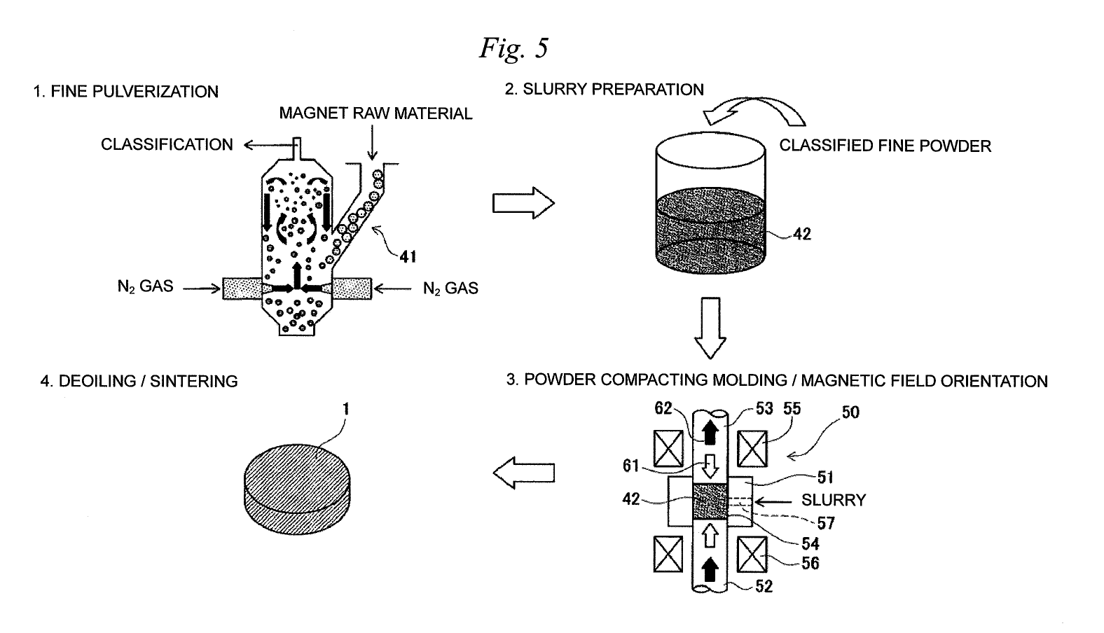

A method for manufacturing the permanent magnet 1 according to this embodiment will be described below using FIG. 5. FIG. 5 is an explanatory view showing a manufacturing process of the permanent magnet 1 according to this embodiment.

First, an ingot comprising, by wt %, 27 to 30% of Nd, 60 to 70% of Fe and 1 to 2% of B is produced. Thereafter, the ingot is crudely pulverized to a size of about 200 μm with a stamp mill, a crusher or the like.

Then, the crudely pulverized magnet powder is finely pulverized with a jet mill 41 in (a) an atmosphere composed of N₂ gas and/or Ar gas having an oxygen content of substantially 0% or (b) an atmosphere composed of N₂ gas and/or Ar gas having an oxygen content of 0.005 to 0.5% to a grain size of about 0.3 to 5 μm. Incidentally, the term “an oxygen concentration of substantially 0%” is not limited to the case where the oxygen concentration is completely 0%, but means that oxygen may be contained in such an amount that an oxide layer is only slightly formed on a surface of the fine powder.

Further, a container containing the rust preventive oil is disposed in a fine powder recovery port of the jet mill 41. Here, as the rust preventive oil, there is used a mineral oil, a synthetic oil or a mixed oil thereof. Furthermore, the Dy compound is previously added to and dissolved in the rust preventive oil. As the Dy compound to be dissolved, one soluble in the rust preventive oil is appropriately selected to use, for example, from Dy-containing organic matter, more particularly, from dysprosium cation-containing organic acid salts (such as aliphatic carboxylic acid salts, aromatic carboxylic acid salts, alicyclic carboxylic acid salts and alkyl aromatic carboxylic acid salts) and dysprosium cation-containing organic complexes (such as acetylacetonates, phthalocyan complexes and merocyan complexes).

Further, even though insoluble in a solvent, Dy or the Dy compound pulverized to fine particles is added at the time of wet dispersion and uniformly dispersed, whereby uniform adhesion to the surfaces of the Nd magnet particles becomes possible.

Furthermore, the amount of the Dy compound to be dissolved is not particularly limited, but it is preferably adjusted to such an amount that the content of the Dy component contained in the Dy compound reaches 0.01 to 8 wt % based on the magnet powder.

Incidentally, the Tb compound, the fine Dy particles or the fine Tb particles may be dissolved in the rust preventive oil, in place of the Dy compound.

Successively, the fine powder classified with the jet mill 41 is recovered in the rust preventive oil without exposing to the atmosphere, and the fine powder of the magnet raw material and the rust preventive oil are mixed with each other to prepare a slurry 42. Incidentally, the inside of the container containing the rust preventive oil is brought to an atmosphere composed of N₂ gas and/or Ar gas.

Thereafter, the prepared slurry 42 is subjected to powder compacting molding by a molding apparatus 50 to form a predetermined shape. Incidentally, the powder compacting molding includes a dry method in which a dried fine powder is filled in a cavity and a wet method in which a fine powder is slurried with a solvent or the like, and then, filled in a cavity. In this embodiment, the wet method is used.

As shown in FIG. 5, the molding apparatus 50 has a cylindrical mold 51, a lower punch 52 slidable up and down with respect to the mold 51 and an upper punch 53 similarly slidable up and down with respect to the mold 51, and a space surrounded therewith constitutes a cavity 54.

Further, in the molding apparatus 50, a pair of magnetic field generating coils 55 and 56 are disposed in upper and lower positions of the cavity 54, and apply magnetic lines of force to the slurry 42 filled in the cavity 54. Furthermore, the mold 51 is provided with a slurry injection hole 57 which opens to the cavity 54.

And when the powder compacting molding is performed, the slurry 42 is first filled in the cavity 54 through the slurry injection hole 57. Thereafter, the lower punch 52 and the upper punch 53 are driven to apply pressure to the slurry 42 filled in the cavity 54 in a direction of arrow 61, thereby performing molding. Further, at the same time of applying the pressure, a pulsed magnetic field is applied to the slurry 42 filled in the cavity 54 in a direction of arrow 62 parallel to the pressure-applied direction by the magnetic field generating coils 55 and 56, whereby the magnetic field is orientated in a desired direction. Incidentally, it is necessary that the direction in which the magnetic field is orientated is determined, taking into account the magnetic field direction required for the permanent magnet 1 molded from the slurry 42.

Furthermore, the slurry is injected while applying the magnetic field to the cavity 54, and a magnetic field stronger than the initial magnetic field may be applied in the course of the injection or after termination of the injection to perform wet molding. In addition, the magnetic field generating coils 55 and 56 may be disposed so that the pressure-applied direction becomes perpendicular to the magnetic field-applied direction.

Then, a molded body obtained by the powder compacting molding is heated under reduced pressure to remove the rust preventing oil in the molded body. Conditions of heat treatment of the molded body under reduced pressure are a degree of vacuum of 13.3 Pa (about 0.1 Torr) or less, for example, about 6.7 Pa (about 5.0×10⁻² Torr) and a heating temperature of 100° C. or more, for example, about 200° C. Further, the heating time varies depending on the weight of the molded body or the throughput, but it is preferably 1 hour or more.

Thereafter, sintering of the deoiled molded body is performed. Incidentally, the sintering is performed at a degree of vacuum of 0.13 Pa (about 0.001 Torr) or less, preferably 6.7×10⁻² Torr (about 5.0×10⁻⁴ Torr) or less, in the range of 1,100 to 1,150° C. for about 1 hour. Then, as a result of the sintering, the permanent magnet 1 is manufactured.

As described above, in the permanent magnet 1 and the method for manufacturing the permanent magnet 1 according to the invention, the magnet raw material including, by wt %, 27 to 30% of Nd, 60 to 70% of Fe and 1 to 2% of B is dry pulverized with the jet mill. Then, the pulverized fine powder is mixed with the rust preventive oil in which the Dy compound (or any one of the Tb compound, the fine Dy particles and the fine Tb particles) is dissolved, thereby preparing the slurry 42. The slurry 42 prepared is wet molded, and thereafter deoiled and sintered, thereby manufacturing the permanent magnet 1. Accordingly, oxidation of the pulverized magnet raw material can be prevented by mixing the magnet raw material with the rust preventive oil.

Further, it becomes possible to unevenly distribute a slight amount of the Dy compound (or any one of the Tb compound, the fine Dy particles and the fine Tb particles) dissolved in the mixed rust preventive oil in grain boundaries of magnet particles, thereby being able to sufficiently improve the coercive force due to Dy or Tb while decreasing the amount of Dy or Tb used.

Furthermore, when the molded body is sintered under proper sintering conditions, Dy or Tb can be prevented from being solid-solutionized into the magnet particles. Accordingly, the residual magnetization of the magnet 1 can be prevented from being decreased.

Incidentally, the invention should not be construed as being limited to the above-mentioned example, and it is of course that various improvements and modifications are possible without departing from the gist of the invention.

In addition, the pulverizing conditions, kneading conditions and sintering conditions of the magnet powder should not be construed as being limited to the conditions described in the above-mentioned example.

While the invention has been described in detail with reference to the specific embodiment thereof, it will be apparent to one skilled in the art that various changes and modifications can be made therein without departing from the spirit and scope of the invention.

Incidentally, this application is based on Japanese Patent Application No. 2008-105761 filed on Apr. 15, 2008, the entire contents of which are incorporated herein by reference.

Further, all references cited herein are incorporated by reference in their entirety.

### INDUSTRIAL APPLICABILITY

According to the permanent magnet of the invention, oxidation of the pulverized magnet raw material can be prevented by mixing the magnet raw material with the rust preventive oil. Further, it becomes possible to unevenly distribute a slight amount of the Dy compound or the Tb compound dissolved in the mixed rust preventive oil in grain boundaries of magnet particles, thereby being able to sufficiently improve the coercive force due to Dy or Tb while decreasing the amount of Dy or Tb used. Furthermore, it can be prevented that Dy or Tb is solid-solutionized in the magnet particles to decrease the residual magnetization.

### DESCRIPTION OF REFERENCE NUMERALS AND SIGNS

1: Permanent magnet
35: Nd magnet particle
36: Dy layer
42: Slurry

1. A permanent magnet manufactured by steps of:
pulverizing a magnet raw material;
mixing the pulverized magnet raw material with a rust preventive oil in which a Dy compound or a Tb compound is dissolved, thereby preparing a slurry;
compression molding the slurry to form a molded body; and
sintering the molded body.

2. The permanent magnet according to claim 1, wherein the Dy compound or the Tb compound is unevenly distributed in a grain boundary of the magnet raw material after sintering.

3. The permanent magnet according to claim 1, wherein the Dy compound or the Tb compound is contained in an amount of from 0.01 to 8 wt %.

4. A permanent magnet manufactured by steps of:
pulverizing a magnet raw material;
mixing the pulverized magnet raw material with a rust preventive oil in which fine Dy particles or fine Tb particles are dissolved, thereby preparing a slurry;
compression molding the slurry to form a molded body; and
sintering the molded body.

5. The permanent magnet according to claim 4, wherein the fine Dy particles or the fine Tb particles are unevenly distributed in a grain boundary of the magnet raw material after sintering.

6. The permanent magnet according to claim 4, wherein the fine Dy particles or the fine Tb particles are contained in an amount of from 0.01 to 8 wt %.

7. A method for manufacturing a permanent magnet, comprising steps of:
pulverizing a magnet raw material;
mixing the pulverized magnet raw material with a rust preventive oil in which a Dy compound or a Tb compound is dissolved, thereby preparing a slurry;
compression molding the slurry to form a molded body; and
sintering the molded body.

8. The permanent magnet according to claim 7, wherein the Dy compound or the Tb compound is contained in an amount of from 0.01 to 8 wt %.

9. A method for manufacturing a permanent magnet, comprising steps of:
pulverizing a magnet raw material;
mixing the pulverized magnet raw material with a rust preventive oil in which fine Dy particles or fine Tb particles are dissolved, thereby preparing a slurry;
compression molding the slurry to form a molded body; and
sintering the molded body.

10. The permanent magnet according to claim 9, wherein the fine Dy particles or the fine Tb particles are contained in an amount of from 0.01 to 8 wt %.

11. The permanent magnet according to claim 2, wherein the Dy compound or the Tb compound is contained in an amount of from 0.01 to 8 wt %.

12. The permanent magnet according to claim 5, wherein the fine Dy particles or the fine Tb particles are contained in an amount of from 0.01 to 8 wt %.
